(19) United States
(12) Patent Application Publication
(10) Pub. No.: US 2024/0280515 A1
(43) Pub. Date: Aug. 22, 2024

(54) X-RAY DETECTOR SYSTEM WITH AT LEAST TWO STACKED FLAT BRAGG DIFFRACTORS

(71) Applicant: Sigray, Inc., Concord, CA (US)

(72) Inventors: Wenbing Yun, Walnut Creek, CA (US); Janos Kirz, Berkeley, CA (US)

(21) Appl. No.: 18/439,625

(22) Filed: Feb. 12, 2024

Related U.S. Application Data
(60) Provisional application No. 63/485,327, filed on Feb. 16, 2023.

(51) Int. Cl. G01N 23/20008; G01N 23/085; G01N 23/20091; G01N 23/207

(52) U.S. Cl. CPC G01N 23/20008; G01N 23/085; G01N 23/20091; G01N 23/2076; G01N 23/2209; G21K 1/06; G21K 1/062; G01N 2223/041; G01N 2223/0563; G01N 2223/0568; G01N 2223/076; G01N 2223/1016; G01N 2223/315

(57) ABSTRACT

An apparatus includes a plurality of stacked flat Bragg diffractors having at least a first flat Bragg diffractor and a second flat Bragg diffractor. The first and second flat Bragg diffractors are positioned sequentially along an x-ray propagation axis of an x-ray beam. The x-ray beam includes x-rays and has an angular beam divergence less than 30 mrad in at least one direction.

### CLAIM OF PRIORITY

This application claims the benefit of priority to U.S. Provisional Appl. No. 63/485,327 filed Feb. 16, 2023, which is incorporated in its entirety by reference herein.

### BACKGROUND

### Field

This application relates generally to x-ray analysis and/or spectroscopy systems.

### Description of the Related Art

Parallel beam wavelength dispersive spectrometers (PBWDS) diffract narrow spectral (e.g., energy) bands of x-rays of differing energies in different directions, according to Bragg's law, by impinging a single flat Bragg x-ray diffractor (e.g., single crystal; mosaic crystal) with a parallel (e.g., collimated) x-ray beam and measuring a selected portion of the diffracted x-rays using an x-ray detector. PBWDSs can be used to measure a specific x-ray energy (e.g., a characteristic fluorescence x-ray line of an atomic element or an energy point in x-ray absorption spectroscopy) or for measuring x-ray spectra over an energy range by varying the Bragg angle between the x-rays and the crystallographic planes of the x-ray diffractor. PBWDSs can offer higher spectral resolution than do energy dispersive detectors (e.g., silicon drift detectors, lithium drifted silicon detectors, lithium drifted germanium detectors, photon counting detectors) and can be used in many x-ray spectroscopy techniques, including but not limited to: elemental (e.g., composition) analysis of a sample by measuring the x-ray fluorescence (XRF) spectrum (e.g., characteristic x-ray lines) emitted from a sample resulting from excitation by ionizing radiation (e.g., energetic electrons, x-rays, protons); x-ray absorption spectroscopy (XAS) by either analyzing x-ray absorption spectra of x-rays transmitted through a sample (e.g., transmission mode XAS) or irradiating a sample with a tunable monochromatic x-ray beam having an x-ray energy range while measuring intensities of characteristic fluorescence x-rays of an element in the sample (e.g., fluorescence mode XAS); or x-ray emission spectroscopy (XES) by measuring x-ray emission spectra of an element inside an object excited by ionizing radiation, e.g., x-rays, electrons, or protons.

### SUMMARY

In certain implementations, an apparatus comprises a plurality of stacked flat Bragg diffractors comprising at least a first flat Bragg diffractor and a second flat Bragg diffractor. The first and second flat Bragg diffractors are positioned sequentially along an x-ray propagation axis of an x-ray beam. The x-ray beam comprises x-rays and has an angular beam divergence less than 30 mrad in at least one direction.

In certain implementations, an apparatus is configured to receive an x-ray beam propagating along an x-ray propagation axis with an angular beam divergence less than 30 mrad in at least one direction substantially perpendicular to the x-ray propagation axis. The apparatus comprises a plurality of sequentially stacked flat Bragg diffractors that are rigidly connected to one another with a separation between adjacent flat Bragg diffractors less than 200 millimeters. The plurality of sequentially stacked flat Bragg diffractors are configured to receive the x-ray beam. Each flat Bragg diffractor of the plurality of sequentially stacked flat Bragg diffractors is configured to diffract a corresponding diffracted portion of the x-ray beam with a spectral overlap between the diffracted portions from different flat Bragg diffractors less than 25%. The apparatus further comprises at least one x-ray detector configured to receive and detect the diffracted portions.

In certain implementations, an apparatus comprises at least one flat Bragg x-ray diffractor configured to receive an x-ray beam and to diffract at least one corresponding diffracted portion of the x-ray beam. The apparatus further comprises at least one energy dispersive x-ray detector configured to receive and detect a transmitted portion of the x-ray beam that is transmitted through the at least one flat Bragg x-ray diffractor.

### BRIEF DESCRIPTION OF THE DRAWINGS

FIGS. 1A and 1B schematically illustrate two examples of an apparatus comprising a plurality of stacked flat Bragg diffractors in accordance with certain implementations described herein.

FIG. 2 schematically illustrates an example fixture configured to hold the plurality of stacked flat Bragg diffractors in accordance with certain implementations described herein.

FIGS. 3A-3D schematically illustrate four additional examples of an apparatus comprising a sequential stack of a plurality of flat Bragg diffractors and at least one first x-ray detector in accordance with certain implementations described herein.

FIGS. 4A-4C schematically illustrate three example x-ray beam sources of a substantially collimated x-ray beam in accordance with certain implementations described herein.

FIGS. 5A-5C schematically illustrate three example apparatus comprising at least one stacked plurality of flat Bragg diffractors in accordance with certain implementations described herein.

### DETAILED DESCRIPTION

X-ray wavelength dispersive spectrometers utilize a flat Bragg diffractor that is impinged by a collimated x-ray beam (e.g., the x-rays propagating substantially parallel to one another along an x-ray propagation axis). For example, the flat Bragg diffractors of x-ray wavelength dispersive spectrometers can include single crystals (e.g., for x-ray energies greater than about 1.47 keV: diamond, quartz, Si, Ge, LiF; for x-ray energies less than about 1.47 keV: InSb, PET, ADP, RAP, beryl, TIAP), mosaic crystals (e.g., highly annealed pyrolitic graphite (HAPG); highly oriented pyrolitic graphite (HOPG)), or multilayers.

The x-ray energy E and the total energy resolution ΔE (e.g., energy bandwidth) of the x-rays diffracted by the flat Bragg diffractor can be expressed as:

$$2 \cdot d \cdot sin ( θ ) = n \cdot λ \qquad ( 1 )$$

$$Δ E = {\{ Δ {E}_{c}^{2} + {[ E \cdot cot ( θ ) \cdot Δθ ]}^{2} \}}^{1 / 2} \qquad ( 2 )$$

where θ is the Bragg angle, d is the spacing of the crystallographic planes of the flat Bragg diffractor, λ is the x-ray wavelength corresponding to the x-ray energy E, n is an integer, Δθ is the angular beam divergence (e.g., angular spread) of the x-ray beam in the tangential plane or diffraction plane (e.g., defined by the x-ray propagation axis of the x-ray beam and the normal direction to the crystallographic planes of the flat Bragg diffractor), and ΔE_{c} is the intrinsic energy resolution of the flat Bragg diffractor (e.g., the value of the total energy resolution ΔE for a highly collimated incident x-ray beam having an angular beam divergence Δθ smaller than or equal to the Darwin width of the flat Bragg diffractor, such as with synchrotron x-ray sources). In certain implementations, the angular beam divergence Δθ in a direction substantially perpendicular to the diffraction plane can be much larger than the angular beam divergence Δθ substantially in the diffraction plane with minimal increase in the total energy resolution Δθ.

The angular contribution term in Exp. (2):

$$[ E \cdot cot ( θ ) \cdot Δθ ] = Δ {E}_{a} \qquad ( 3 )$$

represents the contribution to the total energy resolution ΔE due to the angular beam divergence Δθ of the x-ray beam at the Bragg angle θ. For many applications (e.g., XRF, XAS, and XES), a specific value of the total energy resolution ΔE is desired.

The flat Bragg diffractor diffracts x-rays incident on the flat Bragg diffractor at a point along an x-ray propagation axis within a narrow spectral bandwidth ΔE_{c}, while x-rays of energies outside the narrow spectral bandwidth ΔE_{c} propagating along the same x-ray propagation axis and incident at the same point on the flat Bragg diffractor are not diffracted, so having ΔE_{c} smaller than ΔE leads to inefficient use of the x-rays of the incident x-ray beam.

Previously disclosed PBWDSs exhibit various limitations. For example, previously disclosed PBWDSs perform a single x-ray energy measurement at a time with only x-rays within the energy band ΔE recorded by the x-ray detector. To measure x-rays within different energy bands, the Bragg angle of the flat Bragg diffractor is changed (e.g., measuring two or more characteristic lines for composition analysis using XRF or measuring XAS and XES spectra).

Another example limitation of previously disclosed PBWDSs is inefficiency in performing multiple spectral measurements. For a collimated x-ray beam propagating along an x-ray propagation axis and incident on a point on a flat Bragg diffractor within a narrow angular beam divergence Δθ (e.g., angular spread equal to or less than the Darwin width of the flat Bragg diffractor in the diffraction plane), only the x-rays with energies within the spectral band ΔE_{c} are diffracted, while x-rays with energies outside ΔE_{c} are not diffracted (e.g., absorbed by the crystal), so these x-rays are not analyzed and are wasted, resulting in low analysis efficiency. As an example, the intrinsic spectral band diffracted by a flat Si(531) crystal operating at a Bragg angle of 57.7 degrees for the Cu K_{α1} x-ray line (e.g., about 8 keV) is only 0.06 eV, which is about 35× smaller than the natural radiative Cu K_{α1} linewidth (e.g., about 2.1 eV) and is substantially narrower than the energy resolution (e.g., band) used for most XAS measurements (e.g., x-ray energies for measuring XAS far above the absorption edge ionization energy, which can be up to 6 eV). As another example, while mosaic crystals can diffract a wider spectral band of x-rays than do single crystals, the spectral band can be wider than what is utilized for the analysis (e.g., when used with incident x-ray beams with large beam divergences in the diffraction plane), resulting in wasted x-rays and low analysis efficiency. In addition, mosaic crystals can cause additional angular spread of the transmitted x-rays due to x-ray scattering by small crystal platelets inside the mosaic crystals, which can worsen the energy resolution for a downstream crystal due to increased x-ray beam divergence.

The energy band ΔE of the x-rays diffracted from a point on a flat Bragg diffractor is given by Exp. (2) and can be larger than ΔE_{c} if the angular beam divergence Δθ of the x-ray beam is larger the Darwin width of the flat Bragg diffractor. Except for higher order harmonics (e.g., x-ray enegies of integer multiples of the x-ray energy for a given Bragg angle θ), a single flat Bragg diffractor (e.g., multilayer diffractor, single crystal, mosaic crystal) cannot be used to simultaneously (e.g., concurrently) measure x-rays of two or more x-ray energies with arbitrary large energy differences (e.g., multiple characteristic lines of an atomic element, such as Cu K_{α1} and Cu K_{α2} x-ray lines or K_{α} and K_{β} x-ray lines; multiple characteristic x-ray lines of multiple atomic elements with energy differences greater than 50 eV, greater than 200 eV, greater than 1000 eV, or greater than 5000 eV; multiple energy points).

Another example limitation of previously disclosed PBWDSs is difficulty in balancing between ΔE_{c} and ΔE′ to optimize throughput. For higher throughput (e.g., faster data collection speed), ΔE_{c} can be comparable to or larger than (e.g., greater than or equal to) ΔEₐ with a larger angular beam divergence Δθ, which is often related to the x-ray collection angle (e.g., from a sample for XRF analysis; from a source for XAS analysis). To achieve reasonable energy resolution with a large angular beam divergence Δθ, the flat Bragg diffractor can operate at high Bragg angles but with ΔE_{c} significantly more narrow than the energy resolution ΔE for measurements (e.g., XRF, XAS, and XES). The angular contribution ΔEₐ to the energy resolution ΔE (see Exp. (3)) constrains the minimum Bragg angle to satisfy a given energy resolution ΔE (see Exp. (2)) for a given angular beam divergence Δθ.

For example, for ΔEₐ=2 eV with Δθ=1 mrad, a Bragg angle θ greater than 78.7 degrees can be used for an x-ray energy E=10 keV. The same minimum Bragg angle can be used for ΔEₐ=20 eV with Δθ=10 mrad and E=10 keV. With such high Bragg angles for many applications, ΔE_{c} of a single flat Bragg diffractor is much narrower than the energy resolution used for many XRF applications, resulting in low analysis efficiency, especially when using crystals operating at high Bragg angles (e.g., for large angular beam divergence Δθ of the x-ray beam). As an example, for a Bragg angle θ=70 degrees and x-ray energy E=8.5 keV, the ΔE_{c} of Ge(551), Si(551), and LiF(333) crystal planes are 0.08 eV, 0.03 eV, and 0.03 eV, respectively. These values are significantly narrower than the natural linewidth of characteristic x-ray lines in the 8 keV-10 keV energy range (e.g., linewidth of 2.1 eV for the Cu K_{α1} x-ray line at 8 keV; linewidth of 2.2 eV for the Zn K_{α1} x-ray line at 9.2 keV; linewidth of 6 eV for the W L_{α1} x-ray line at 8.4 keV). Therefore, these crystals are highly inefficient for measuring these characteristic x-rays when operating at high Bragg angles. The inefficiency becomes more severe for measuring higher energy x-rays because ΔE_{c} decreases with x-ray energy for most single crystals operating at high Bragg angles while the natural linewidth of characteristic x-ray lines increases with x-ray energy. For example, ΔEₐ of Li(1022) crystal planes at a Bragg angle θ=66.5 degrees for E=17.4 keV x-rays is 0.01 eV, while the natural linewidth of the Mo K_{α1} x-ray line at 17.4 keV is about 6.5 eV (e.g., a ratio between the two is about 650×). Even at moderate Bragg angles (e.g., θ=30 degrees) for E=8.5 keV x-rays, ΔE_{c} of Ge(331), Si(331), and LiF(220) crystal planes are 0.31 eV, 0.13 eV, and 0.23 eV, respectively. These values are also much narrower than the energy resolution used for most XRF and XAS measurements and these crystals are therefore inefficient for measuring characteristic x-ray lines at x-ray energies around 8.5 keV or for XAS measurements with x-ray energies around 8.5 keV. To get the energy resolution ΔE_{c} to approach 2 eV for E=8.5 keV x-rays, Bragg angles θ that are less than 23 degrees can be used for single Ge crystal flat Bragg diffractors and less than 14 degrees for single crystal Si, LiF, or diamond flat Bragg diffractors.

The x-ray flux of a parallel x-ray beam generally increases with the angular beam divergence 30, so operating at small Bragg angles is generally not desirable in order to achieve small angular contributions to the energy resolution (e.g., ΔEₐ<ΔE) since the small Bragg angles reduce the x-ray flux (e.g., characteristic x-rays) from a sample. Furthermore, the angular contribution to the energy resolution is generally significantly smaller than the energy separations between characteristic K x-ray lines of most atomic elements (e.g., about 20 eV between the Cu K_{α1} and Cu K_{α2} x-ray lines) and the energy separations between the L x-ray lines of many atomic elements. However, using flat Bragg diffractors at low Bragg angles (e.g., less than 20 degrees) can provide better match with the energy bandwidth of characteristic x-ray lines of many atomic elements, with x-ray beams having much smaller angular beam divergence Δθ, resulting in efficient collection of characteristic x-ray lines from a sample. The energy resolution ΔE_{c} of many single crystal flat Bragg diffractors is also much narrower than the energy resolution (e.g., bandwidth) used for most XAS measurements, especially for x-ray energies for measuring EXAFS far above the absorption edge ionization energy, for which energy resolution up to 6 eV can be used. However, the spectral resolution of mosaic crystals (e.g., HOPG; HAPG) can be too wide for the various (e.g., XANES; XES) analyses.

Another example limitation of previously disclosed PBWDSs is that only narrow spectral (e.g., energy) bands of x-rays are diffracted by a single flat Bragg diffractor. To measure a wide spectral range (e.g., concurrently measuring a Cu La x-ray line with a Cu K_{α} x-ray line; concurrently measuring a C K_{α} x-ray line with a Cu K_{α1} x-ray line), different flat Bragg diffractors could be used sequentially in time (e.g., measuring with a first flat Bragg diffractor, then switching to a second flat Bragg diffractor and measuring with the second flat Bragg diffractor, etc.) to cover the wide spectral range. For example, crystal diffractors can be used for hard (e.g., energies greater than 5 keV) x-rays or multilayers can be used for soft (e.g., energies less than 1 keV) x-rays. Certain implementations described herein use a plurality of stacked flat Bragg diffractors (e.g., crystal diffractors) to obtain a predetermined total energy resolution while operating at moderate (e.g., 30 to 45 degrees) and high (e.g., greater than 60 degrees) Bragg angles. Certain implementations described herein utilize flat Bragg diffractors with values of the intrinsic energy resolution ΔE_{c} that approach (e.g., are substantially equal to) the total energy resolution ΔE to obtain efficient use of the incident x-rays having x-ray energies within the energy bandwidth ΔE. For small differences between ΔE_{c} and ΔE (e.g., which can be considered a measure of efficiency of a flat Bragg diffractor), the angular contribution ΔEₐ (see Exp. (3)) is configured to be small. For example, small values of ΔEₐ can be obtained with large Bragg angles θ, small angular beam divergences Δθ, or combination of both. The incident x-ray beam flux increases with the angular beam divergence Δθ, so certain implementations described herein provide increased x-ray analysis speed to impinge the stacked flat Bragg diffractors with the x-ray beam at high Bragg angles to obtain ΔE_{c} close to ΔE.

Certain implementations described herein provide an energy dispersive detector system comprising at least two stacked flat Bragg diffractors and an energy dispersive detector positioned to receive diffracted x-rays from the at least two stacked flat Bragg diffractors. The energy dispersive detector has an energy resolution equal to or greater than the energy difference of the mean x-ray energies of the x-rays diffracted by the at least two stacked flat Bragg diffractors. For example, at least two stacked flat crystal diffractors and one x-ray detector can be configured such that the x-ray detector receives some x-rays diffracted by the at least two stacked flat crystal diffractors and the x-ray detector has an energy resolution comparable to or greater than the energy difference of the mean x-ray energies of the x-rays diffracted by the at least two stacked flat crystal diffractors. In certain implementations, the energy dispersive detector system reduces (e.g., minimizes) the number of x-ray detectors that are used (e.g., by selecting the Bragg angles of the at least two stacked flat crystal diffractors, the distances between the at least two stacked flat crystal diffractors, and the relative position of the x-ray detector relative to the at least two stacked flat crystal diffractors). The stacked flat crystal diffractors can comprise different materials from one another or can comprise the same materials as one another, but with different Miller indices. The x-ray detector can be an energy dispersive detector (e.g., silicon drift detector, Li-drift silicon or germanium detector, photon counting detector with selectable energy window, superconductor based microcalorimeter).

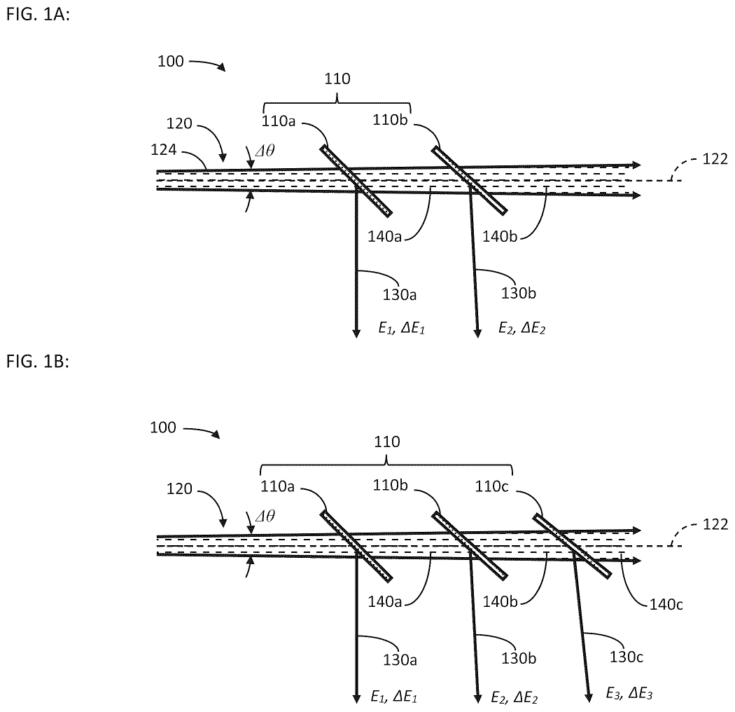

FIGS. 1A and 1B schematically illustrate two examples of an apparatus 100 (e.g., x-ray crystal diffractor; array of sequentially arranged flat Bragg diffractors; PBWDS) in accordance with certain implementations described herein. The apparatus 100 comprises a plurality of stacked flat Bragg diffractors 110 comprising at least first and second flat Bragg diffractors 110a, 110b (e.g., multilayers; single crystals; mosaic crystals) positioned sequentially along an x-ray propagation axis 122 of an x-ray beam 120 comprising x-rays 124 and having an angular beam divergence Δθ less than 30 mrad (e.g., less than 10 mrad; less than 2 mrad; less than 0.2 mrad) in at least one plane comprising the x-ray propagation axis 122 (e.g., in at least one direction substantially perpendicular to the x-ray propagation axis 122). For example, at least one flat Bragg diffractor 110 of the plurality of stacked flat Bragg diffractors 110 can comprise a multilayer structure comprising periodic layers of alternating high mass density and low mass density materials (e.g., Cr/C; W/C; Mo/Si) with a d-spacing in a range of 3 nanometers to 30 nanometers), a single crystal selected from the group consisting of: diamond, quartz, graphite, stack of graphene layers, other materials comprising low atomic number elements, silicon (Si), germanium (Ge), lithium fluoride (LiF), mica, indium antimonide (InSb), polyethylene terephthalate (PET), ammonium dihydrophosphate (ADP), rubidium acid phtahalate (RAP), beryl, and thallium acid phthalate (TIAP) and/or mosaic crystals selected from the group consisting of highly annealed pyrolitic graphite (HAPG) and highly oriented pyrolitic graphite (HOPG).

As used herein, the term “flat Bragg diffractor” has its broadest reasonable interpretation, including but not limited to a diffractor comprising a substantially flat (e.g., planar; radius of curvature greater than 100 meters) multilayer, single crystal, or mosaic crystal configured to diffract x-rays in accordance with Bragg's law. As used herein, the term “stacked flat Bragg diffractors” has its broadest reasonable interpretation, including but not limited to a plurality of flat Bragg diffractors that are connected (e.g., rigidly affixed) to one another through mechanical linkages (e.g., by a common fixture with or without angular adjustments between them) and are configured such that the flat Bragg diffractors are sequentially impinged by the x-ray beam (e.g., sequentially disposed along the x-ray beam axis). For example, the x-ray beam is incident on (e.g., impinges) a first flat Bragg diffractor (e.g., an upstream-most flat Bragg diffractor) and a portion of the x-ray beam transmitted through the first flat Bragg diffractor is incident on (e.g., impinges) a second flat Bragg diffractor (e.g., a next flat Bragg diffractor downstream from the upstream-most flat Bragg diffractor), with a portion of the x-ray beam transmitted through the second flat Bragg diffractor. For an example with more than two flat Bragg diffractors, the portions transmitted through the flat Bragg diffractors are incident on (e.g., impinge) the next downstream flat Bragg diffractors, until a downstream-most flat Bragg diffractor receives (e.g., is impinged by) the portion of the x-ray beam transmitted through the previous flat Bragg diffractor. As used herein, the term “flat Bragg diffractor” used in singular form includes a single flat Bragg diffractor and a single stack of flat Bragg diffractors, unless specifically stated. As used herein, the terms “multiple flat Bragg diffractors,” “a plurality of flat Bragg diffractors,” and “two flat Bragg diffractors” have their broadest reasonable interpretations, including but not limited to two or more individual flat Bragg diffractors and/or two or more stacks of flat Bragg diffractors.

For example, as shown in FIGS. 1A and 1B, the second flat Bragg diffractor 110b is downstream from the first flat Bragg diffractor 110a (e.g., the second flat Bragg diffractor 110b can be further from a source of the x-ray beam 120 than is the first flat Bragg diffractor 110a). The first flat Bragg diffractor 110a is configured to diffract a first diffracted portion 130a of the x-rays 124 and to transmit a first transmitted portion 140a of the x-rays 124, and the second flat Bragg diffractor 110b is configured to diffract a second diffracted portion 130b of the first transmitted portion 140a and to transmit a second transmitted portion 140b of the first transmitted portion 140a. The first diffracted portion 130a has a first mean (e.g., central) x-ray energy E₁ and a first energy resolution ΔE₁ and the second diffracted portion 130b has a second mean (e.g., central) x-ray energy E₂ and a second energy resolution ΔE₂, the second x-ray energy E₂ different from the first x-ray energy E₁.

While the example apparatus 100 of FIG. 1A comprises the first and second flat Bragg diffractors 110a,b, the example apparatus 100 of FIG. 1B comprises first, second, and third flat Bragg diffractors 110a,b,c stacked with one another and positioned sequentially along the x-ray propagation axis 122 (e.g., the third flat Bragg diffractor 110c downstream from the second flat Bragg diffractor 110b). The third flat Bragg diffractor 110c can be configured to diffract a third diffracted portion 130c of the second transmitted portion 140b and to transmit a third transmitted portion 140c of the second transmitted portion 140b. The third diffracted portion 130c can have a third mean (e.g., central) x-ray energy E₃ and a third energy resolution ΔE₃, the third x-ray energy E₃ different from the first x-ray energy E₁ and from the second x-ray energy E₂. In certain implementations, positioning and alignment of one or more flat Bragg diffractors 110 (e.g., the first flat Bragg diffractor 110a, the second flat Bragg diffractor 110b, and/or the third flat Bragg diffractor 110c) relative to the x-ray propagation axis 122 is performed, individually or simultaneously, using adjustment mechanisms of the fixture (e.g., computer controlled motorized adjustment mechanisms).

In certain implementations, the plurality of stacked flat Bragg diffractors 110 comprises two or more flat Bragg diffractors 110 (e.g., 2, 3, 4, or 5; 2 to 10; 5 to 10; less than 20; less than 100; more than 5; more than 20; more than 100) stacked with one another and positioned sequentially along the x-ray propagation axis 122. The maximum number of flat Bragg diffractors 110 can be limited by the cumulative x-ray transmission of the plurality of stacked flat Bragg diffractors 110.

In certain implementations, the plurality of stacked flat Bragg diffractors 110 can be configured to diffract more than three (e.g., more than 10; more than 20; more than 30) characteristic x-ray lines simultaneously with energy resolutions better than 30 eV (e.g., for XRF analysis with scanning electron microscopes and micro XRF systems). In certain implementations, at least one flat Bragg diffractor 110 is configured to diffract a single characteristic x-ray line (e.g., two stacked flat Bragg diffractors 110 comprising LiF crystals configured to diffract the Cu K_{α1} x-ray line). The energy resolution can be better than 2 eV with an x-ray beam 120 with an angular beam divergence of 10 mrad, and with the stacked flat Bragg diffractors 110 operated at high Bragg angles such that the Darwin width limited energy resolutions are narrower than the energy bandwidth of the characteristic x-ray lines to be measured.

In certain implementations, at least the upstream-most flat Bragg diffractor 110 (e.g., the first flat Bragg diffractor 110a) of the plurality of stacked flat Bragg diffractors 110 comprises a multilayer Bragg diffractor configured to diffract x-rays 124 having x-ray energies less than 1 keV (e.g., a C K_{α} x-ray line). The next downstream flat Bragg diffractor 110 (e.g., the second flat Bragg diffractor 110b) of the plurality of stacked flat Bragg diffractors 110 can comprise PET, ADP, or RAP and can be configured to diffract x-rays 124 having x-ray energies greater than 1 keV (e.g., in a range of 1 keV to 3 keV), and the downstream-most flat Bragg diffractor 110 (e.g., the third flat Bragg diffractor 110c) of the plurality of stacked flat Bragg diffractors 110 can comprise a single crystal or a mosaic crystal and can be configured to diffract x-rays 124 having x-ray energies greater than 3 keV (e.g., greater than 5 keV). In certain implementations, at least one flat Bragg diffractor 110 is configured to diffract x-rays 124 having a characteristic x-ray line energy of a predetermined atomic element and another at least one flat Bragg diffractor 110 is configured to diffract x-rays 124 having x-ray energies close to but different from the characteristic x-ray line energy (e.g., energy difference greater than the energy bandwidth of the characteristic x-ray line and less than or equal to 140 eV, less than 50 eV, less than 10 eV) to measure a background contribution (e.g., not resulting from the characteristic x-ray line) to the detected x-rays.

In certain implementations, the plurality of stacked flat Bragg diffractors 110 are positioned along the x-ray propagation axis 122 within a distance along the x-ray propagation axis less than 200 millimeters (e.g., the distance between the upstream-most flat Bragg diffractor 110 and the downstream-most flat Bragg diffractor 110 is less than 200 millimeters). In certain implementations, at least two adjacent flat Bragg diffractors 110 are positioned along the x-ray propagation axis 122 spaced from one another along the x-ray propagation axis 122 by less than 200 millimeters (e.g., less than 50 millimeters; less than 30 millimeters; less than 20 millimeters; less than 10 millimeters; less than 2 millimeters; less than 1 millimeter; less than 0.2 millimeter). In certain implementations, each flat Bragg diffractor 110 of the plurality of stacked flat Bragg diffractors 110 (e.g., first and second flat Bragg diffractors 110a,b) can simultaneously satisfy the Bragg conditions for the x-ray beam 120 having an angular beam divergence Δθ less than 15 mrad (e.g., less than 3 mrad; less than 1 mrad; less than 0.3 mrad) in the diffraction plane within an energy bandwidth less than 25 eV (e.g., less than 10 eV; less than 5 eV; less than 1 eV) with intensity overlap of the x-ray energies of at least two of the diffracted portions 130 less than 5% (e.g., less than 1%).

In certain implementations, at least one flat Bragg diffractor 110 of the plurality of stacked flat Bragg diffractors 110 is symmetrically cut, while in certain other implementations, at least one flat Bragg diffractor 110 of the plurality of stacked flat Bragg diffractors 110 is asymmetrically cut (e.g., increasing its effective Darwin width by a factor of 1.2 to 5; decreasing its effective Darwin width by a factor of 1.2 to 5) to diffract x-rays 124 with an energy resolution different from (e.g., wider or narrower than) the symmetrically cut form of the at least one flat Bragg diffractor 110. In certain implementations, at least one flat Bragg diffractor 110 of the plurality of stacked flat Bragg diffractors 110 comprises an asymmetrically cut crystal is configured to be rotated by 180 degrees, to switch the at least one flat Bragg diffractor 110 of the plurality of stacked flat Bragg diffractors 110 from an increased effective Darwin width to a decreased effective Darwin width, or vice versa.

In certain implementations, at least two flat Bragg diffractors 110 of the plurality of stacked flat Bragg diffractors 110 (e.g., first and second flat Bragg diffractors 110a,b; first and third flat Bragg diffractors 110a,c; second and third flat Bragg diffractors 110b,c; first, second, and third flat Bragg diffractors 110a,b,c) comprise the same material as one another. In certain implementations, at least two flat Bragg diffractors 110 of the plurality of stacked flat Bragg diffractors 110 (e.g., first and second flat Bragg diffractors 110a,b; first and third flat Bragg diffractors 110a,c; second and third flat Bragg diffractors 110b,c; first, second, and third flat Bragg diffractors 110a,b,c) comprise different materials from one another. The at least two flat Bragg diffractors 110 of the plurality of stacked flat Bragg diffractors 110 can be configured to simultaneously satisfy the Bragg conditions for the incident x-rays 124 propagating along the x-ray propagation axis 122 with small angular beam divergence (e.g., less than 30 mrad; less than 20 mrad; less than 10 mrad; less than 5 mrad; less than 3 mrad; less than 2 mrad; less than 1 mrad; less than 0.3 mrad; less than 0.2 mrad) within a narrow spectral bandwidth (e.g., less than 25 eV; less than 10 eV; less than 5 eV; less than 2 eV; less than 1 eV) with minimal (e.g., less than 5%; less than 1%) overlap of diffracted x-ray intensities by the at least two flat Bragg diffractors 110.

At least one flat Bragg diffractor 110 of the plurality of stacked flat Bragg diffractors 110 (e.g., the upstream-most flat Bragg diffractor 110; the first flat Bragg diffractor 110a of FIG. 1A; each of the first and second flat Bragg diffractors 110a,b of FIG. 1B) can have a thickness (e.g., along the x-ray propagation axis 122) greater than 1 micron (e.g., greater than 2 microns) and less than 500 microns (e.g., less than 300 microns; less than 100 microns; less than 50 microns; less than 20 microns; less than 5 microns). For example, in FIG. 1A, the thickness of the first flat Bragg diffractor 110a can be greater than or equal to an extinction length for x-rays 124 having the second x-ray energy E₂ in the material of the first flat Bragg diffractor 110a. For another example, in FIG. 1B, the thickness of the first flat Bragg diffractor 110a can be greater than or equal to an extinction length for x-rays 124 having the second x-ray energy E₂ and for x-rays 124 having the third x-ray energy E₃ in the material of the first flat Bragg diffractor 110a, and the thickness of the second flat Bragg diffractor 110b can be greater than or equal to an extinction length for x-rays 124 having the third x-ray energy E₃ in the material of the second flat Bragg diffractor 110b.

Each flat Bragg diffractor 110 of the plurality of stacked flat Bragg diffractors 110 can have an x-ray transmittance greater than 1% (e.g., greater than 2%; greater than 5%; greater than 30%) for x-rays 124 that are diffracted by a downstream flat Bragg diffractor 110. For example, in FIG. 1A, the first flat Bragg diffractor 110a can have a first x-ray transmittance greater than 1% for x-rays 124 having the second x-ray energy E₂. For another example, in FIG. 1B, the first flat Bragg diffractor 110a can have a first x-ray transmittance greater than 1% for x-rays 124 having the second x-ray energy E₂ and a third x-ray transmittance greater than 1% for x-rays 124 having the third x-ray energy E₃, and the second flat Bragg diffractor 110b can have a second x-ray transmittance greater than 1% for x-rays 124 having the third x-ray energy E₃. The plurality of stacked flat Bragg diffractors 110 can have an integrated reflectivity approximately equal to a sum of the integrated reflectivities of the individual flat Bragg diffractors 110 of the plurality of stacked flat Bragg diffractors 110, reduced by x-ray absorption by at least one upstream flat Bragg diffractor 110 (e.g., first flat Bragg diffractor 110a in FIGS. 1A and 1B). The upstream-most flat Bragg diffractor 110 (e.g., the first flat Bragg diffractor 110a) can have an x-ray transmission greater than 50% for x-rays 124 within the energy bandwidth of the diffracted portion 130 of x-rays 124 diffracted by at least one downstream flat Bragg diffractor 110 (e.g., the second flat Bragg diffractor 110b; the third flat Bragg diffractor 110c). The upstream-most flat Bragg diffractor 110 of the plurality of stacked flat Bragg diffractors 110 (e.g., the first flat Bragg diffractor 110a) can have an x-ray transmission greater than that of a downstream flat Bragg diffractor 110 (e.g., the second flat Bragg diffractor 110b) within the total spectral bandwidth of the plurality of stacked flat Bragg diffractors 110. In certain implementations in which the x-rays 124 transmitted through the downstream-most flat Bragg diffractor 110 (e.g., the second flat Bragg diffractor 110b of FIG. 1A; the third flat Bragg diffractor 110c of FIG. 1B) are not to be used for further analysis, the downstream-most flat Bragg diffractor 110 can have a low x-ray transmittance (e.g., comprising Ge or another high atomic number material; having a thickness greater than 300 microns) and/or can have a coarser energy resolution than does the upstream-most flat Bragg diffractor 110 of the plurality of stacked flat Bragg diffractors 110.

The diffracted portions 130 (e.g., the first diffracted portion 130a and the second diffracted portion 130b of FIG. 1A; the first, second, and third diffracted portions 130a,b,c of FIG. 1B) can have a total spectral bandwidth (e.g., a sum of the spectral bandwidths of the diffracted portions 130) that substantially matches a predetermined energy range (e.g., an energy range to be used for a given analysis). The transmitted portion that is transmitted through the downstream-most flat Bragg diffractor 110 (e.g., the second transmitted portion 140b transmitted through the second flat Bragg diffractor 110b of FIG. 1A; the third transmitted portion 140c transmitted through the third flat Bragg diffractor 110c of FIG. 1B) can have sufficient x-ray flux for analysis by one or more x-ray detectors (not shown in FIGS. 1A and 1B) positioned downstream from the downstream-most flat Bragg diffractor 110. In certain implementations, the plurality of stacked flat Bragg diffractors 110 has an x-ray transmittance greater than 3% for x-rays 124 outside the total spectral bandwidths of the diffracted portions 130. For example, the transmitted portion that is transmitted through the downstream-most flat Bragg diffractor 110 has sufficient flux for further analysis by at least one additional spectrometer (e.g., another x-ray stacked crystal diffractor; an array of sequentially arranged flat Bragg diffractors; a single crystal diffractor; a mosaic crystal diffractor; an energy dispersive detector). In certain implementations, the plurality of stacked flat Bragg diffractors 110 contributes an angular spread less than 15 mrad (e.g., less than 10 mrad) to the transmitted portion.

In certain implementations in which the at least two flat Bragg diffractors 110 of the plurality of stacked flat Bragg diffractors 110 (e.g., first and second flat Bragg diffractors 110a,b; first and third flat Bragg diffractors 110a,c; second and third flat Bragg diffractors 110b,c; first, second, and third flat Bragg diffractors 110a,b,c) comprise the same material as one another, the at least two flat Bragg diffractors 110 are configured to diffract x-rays 124 with atomic planes having the same Miller indices as one another (e.g., LiF(111); LiF(200); Si(111)). The mean x-ray energies E of the diffracted portions 130 from each of the at least two flat Bragg diffractors 110 (e.g., the first and second mean energies E₁, E₂ of the first and second flat Bragg diffracted portions 130a,b) can be different from one another and each of the at least two diffracted portions 130 can have a spectral bandwidth that is less than or equal to one-half of the energy resolution IE from the corresponding flat Bragg diffractor 110 (e.g., the first and second diffracted portions 130a,b can have spectral bandwidths of ΔE₁≤0.5·ΔE and ΔE₂≤0.5·ΔE, respectively; the first, second, and third diffracted portions 130a,b,c can have spectral bandwidths of ΔE₁≤0.3·ΔE, ΔE₂≤0.3·ΔE, and ΔE₃≤0.3·ΔE, respectively). The overlap of the spectral bandwidths of at least two diffracted portions 130 can be less than or equal to 5% (e.g., less than 1%) of at least one of the spectral bandwidths. In certain implementations, the difference between the mean energies of at least two diffracted portions 130 is less than or equal to the spectral bandwidth of at least one of the spectral bandwidths (e.g., (E₂−E₁)≤ΔE₁ and/or (E₂−E₁)≤ΔE₂).

For example, the x-rays 124 can be incident to each of the at least two flat Bragg diffractors 110 of the plurality of stacked flat Bragg diffractors 110 at different Bragg angles (e.g., difference of at least one Darwin width but less than 30 Darwin widths (e.g., less than 10, 5, or 3 Darwin widths)) such that there is substantially zero spectral overlap between the diffracted portions 130 from the at least two flat Bragg diffractors 110. The Bragg angle difference can be greater than 10 microradians (e.g., greater than 50 microradians; greater than 500 microradians; greater than 5 mrad; greater than 300 mrad). For another example, the x-rays 124 can be incident to each of the at least two flat Bragg diffractors 110 at substantially equal Bragg angles and the at least two flat Bragg diffractors 110 can have different d-spacings (e.g., difference of at least one Darwin width but less than 30 Darwin widths (e.g., less than 10, 5, or 3 Darwin widths)) of the diffracting atomic planes of the at least two flat Bragg diffractors 110. The different d-spacings can be achieved by having the at least two flat Bragg diffractors 110 at different temperatures. For example, LiF has a thermal expansion coefficient of 37×10⁻⁶/K at 283° C. (e.g., more than 10× higher than that for Si) and a thermal conductivity of 0.113 W/K/cm at 314° C. (e.g., more than 15× lower than that for Si). A combination of temperature difference and relative Bragg angle difference can be used to simultaneously satisfy the Bragg conditions for the incident x-rays 124 propagating along the x-ray propagation axis 122 with small angular beam divergence (e.g., less than 30 mrad; less than 20 mrad; less than 10 mrad; less than 5 mrad; less than 3 mrad; less than 2 mrad; less than 1 mrad; less than 0.3 mrad; less than 0.2 mrad) within a narrow spectral bandwidth (e.g., less than 25 eV; less than 10 eV; less than 5 eV; less than 2 eV; less than 1 eV) with minimal (e.g., less than 5%; less than 1%) overlap of diffracted x-ray intensities by the at least two flat Bragg diffractors 110.

In certain implementations, at least one flat Bragg diffractor 110 of the plurality of stacked flat Bragg diffractors 110 has an upstream-most surface, a downstream-most surface, and a temperature difference between the two surfaces, the temperature difference configured to vary a d-spacing of crystal planes of the at least one flat Bragg diffractor 110. For example, the temperature difference can be generated by heating or cooling one of the two surfaces or by heating one of the two surfaces while cooling the other of the two surfaces). The ratio of the d-spacing change due to the temperature difference to the d-spacing of the crystal planes without the temperature difference can be in a range of 10 microradians to 400 microradians (e.g., in a range of 10 microradians to 50 microradians; in a range of 10 microradians to 200 microradians; in a range of 50 microradians to 200 microradians; in a range of 200 microradians to 400 microradians).

In certain implementations, at least two flat Bragg diffractors 110 of the plurality of stacked flat Bragg diffractors 110 are fabricated from a single crystal block. For example, by removing material from between portions of the single crystal block, different portions of the single crystal block can serve as different flat Bragg diffractors 110 with corresponding predetermined thicknesses and predetermined spacings between adjacent flat Bragg diffractors 110 of the plurality of stacked flat Bragg diffractors 110. The fixture can comprise a tilting mechanism configured to introduce or controllably modify a predetermined angular tilt between the crystal planes of the at least two flat Bragg diffractors 110 (e.g., between 5 microradians and 300 mrad).

In certain other implementations, at least two flat Bragg diffractors 110 of the plurality of stacked flat Bragg diffractors 110 are fabricated separately from one another to have corresponding predetermined materials, thicknesses, and crystal planes with predetermined Miller indices (e.g., at predetermined asymmetric angles relative to the crystal surfaces), and the at least two flat Bragg diffractors 110 are affixed (e.g., connected; mounted) to the fixture such that the at least two flat Bragg diffractors 110 have a predetermined angular tilt between the crystal planes of the at least two flat Bragg diffractors 110 (e.g., between 5 microradians and 300 mrad).

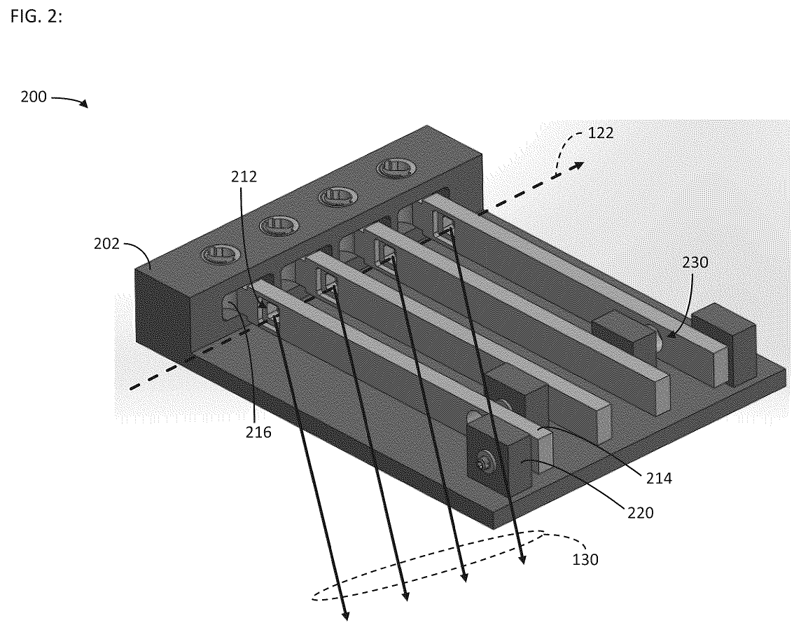

FIG. 2 schematically illustrates an example fixture 200 configured to hold the plurality of stacked flat Bragg diffractors 110 in accordance with certain implementations described herein. The fixture 200 comprises a rigid frame 202 and a plurality of diffractor mounts 210 configured to hold the plurality of stacked flat Bragg diffractors 110 along an x-ray propagation axis 122 of an x-ray beam 120. Each diffractor mount 210 comprises a first portion 212 configured to be affixed to a corresponding flat Bragg diffractor 110 of the plurality of stacked flat Bragg diffractors 110, the first portion 212 substantially transparent to the x-ray beam 120, a second portion 214 configured to be controllably moved to adjust an angle of the corresponding flat Bragg diffractor 110 relative to the x-ray propagation axis 122, and a third portion 216 configured to flex in response to movement of the second portion 214. The first portion 212 can comprise a hole extending through the diffractor mount 210 and/or a membrane having an x-ray transmission (e.g., greater than 50%) to the x-rays 124 to be diffracted by one or more other downstream flat Bragg diffractors 110. The membrane can be configured to support a flat Bragg diffractor 110 that is not sufficiently rigid to be self-supporting across the hole. The fixture 200 can further comprise a plurality of adjustment mechanisms 220 configured to controllably move the second portions 214 of the plurality of diffractor mounts 210 (e.g., manually; electronically). For example, each adjustment mechanism 220 can comprise a threaded through hole and a set screw extending from the through hole and contacting the second portion 214 of the diffractor mount 210. By adjusting the extent of the set screw from the through hole (e.g., manually; electronically), the second portion 214 can be controllably moved against a restoring force generated by the flexing third portion 216 to adjust the angular tilt of the corresponding flat Bragg diffractor 110 (e.g., the diffractor mount 210 serving as a lever arm with the third portion 216 serving as a pivot). In certain implementations, at least one of the diffractor mounts 210 comprises a through hole 230 configured to provide access to the adjustment mechanism 220 (e.g., set screw) mechanically coupled to another of the diffractor mounts 210.

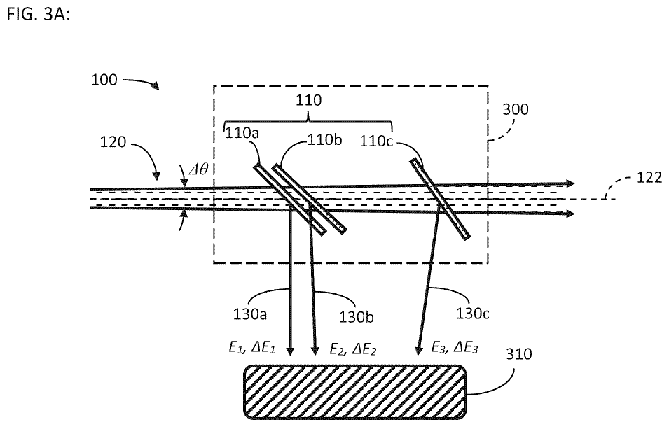

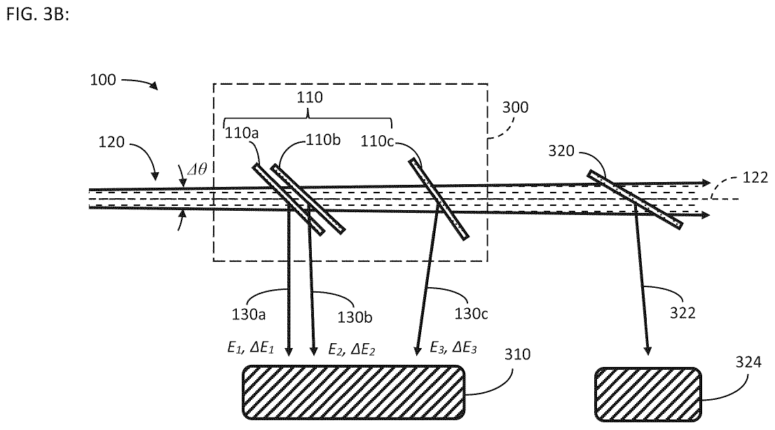

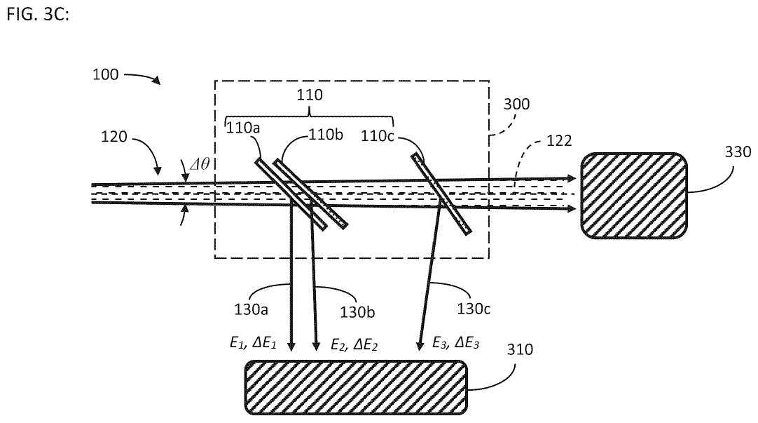

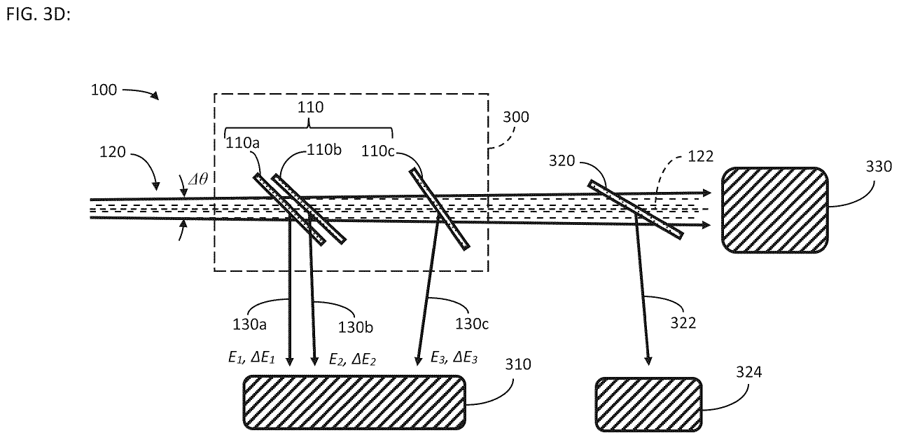

FIGS. 3A-3D schematically illustrate four additional examples of an apparatus 100 (e.g., x-ray crystal diffractor; array of sequentially arranged flat Bragg diffractors) in accordance with certain implementations described herein. The apparatus 100 comprises a sequential stack 300 of a plurality of flat Bragg diffractors 110 (e.g., a plurality of stacked flat Bragg diffractors 110) and at least one first x-ray detector 310. At least two flat Bragg diffractors 110 of the plurality of flat Bragg diffractors 110 (e.g., comprising at least one single crystal and/or at least one mosaic crystal) are stacked with (e.g., mounted to; rigidly attached to) one another such that a separation (e.g., distance) between adjacent flat Bragg diffractors 110 of the at least two flat Bragg diffractors 110 along a direction substantially parallel to the x-ray propagation axis 122 is less than 200 millimeters (e.g., less than 50 millimeters; less than 30 millimeters; less than 20 millimeters; less than 10 millimeters; less than 2 millimeters; less than 1 millimeter; less than 0.2 millimeter). For example, as shown in FIGS. 3A-3D, the first, second, and third flat Bragg diffractors 110a,b,c are stacked with one another and are configured to diffract the first, second, and third diffracted portions 130a,b,c, respectively, in directions towards the at least one first x-ray detector 310. The sequential stack 300 can comprise at least two flat Bragg diffractors 110 of the plurality of flat Bragg diffractors 110 that are mounted to a fixture 200 (see, e.g., FIG. 2) configured to align the spatial positions and/or orientations (e.g., Bragg angles) of the plurality of flat Bragg diffractors 110 relative to the x-ray propagation axis 122. In certain implementations, positioning and alignment of the sequential stack 300, at least some of the plurality of flat Bragg diffractors 110, and/or the at least one first x-ray detector 310 is performed using one or more computer controlled motorized motion stages.

As discussed herein with regard to FIGS. 1A and 1, the first and second diffracted portions 130a,b can have first and second mean x-ray energies E₁ and E₂, respectively, and the third diffracted portion 130c can have a third mean x-ray energy E₃. In addition, the first flat Bragg diffractor 110a can have a first x-ray transmittance greater than 1% for x-rays 124 having the second x-ray energy E₂ and a third x-ray transmittance greater than 1% for x-rays 124 having the third x-ray energy E₃, and the second flat Bragg diffractor 110b can have a second x-ray transmittance greater than 1% for x-rays 124 having the third x-ray energy E₃.

In certain implementations, each of the at least two flat Bragg diffractors 110 of the sequential stack 300 is configured to diffract x-rays 124 towards the at least one first x-ray detector 310, the at least two diffracted portions 130 having mean x-ray energies that differ from one another by less than 30 eV (e.g., less than 10 eV; less than 5 eV; less than 2 eV). In certain implementations, each of the at least two flat Bragg diffractors 110 is configured to diffract x-rays 124 towards the at least one first x-ray detector 310, the at least two diffracted portions 130 having mean x-ray energies that differ from one another by greater than 50 eV (e.g., greater than 100 eV; greater than 200 eV; greater than 500 eV; greater than 2000 eV). The at least two diffracted portions 130 (e.g., first, second, and third diffracted portions 130a,b,c) have substantially no spectral intensity overlap with one another (e.g., less than 5%; less than 1%; less than 0.1%). While FIGS. 3A-3D show three stacked flat Bragg diffractors 110 (e.g., first, second, and third flat Bragg diffractors 110a,b,c), certain other implementations comprise two stacked flat Bragg diffractors 110 or three or more (e.g., 3, 4, or 5; 3 to 10; 5 to 10) stacked flat Bragg diffractors 110.

In certain implementations, the at least one x-ray first detector 310 is configured to receive at least a portion of the diffracted portions 130 of the x-rays 124 diffracted by the plurality of flat Bragg diffractors 110 of the sequential stack 300 and to output detection electrical signals in response to the received diffracted portions 130. For example, as shown in FIGS. 3A-3D, the at least one first x-ray detector 310 is configured to receive the first, second, and third diffracted portions 130a,b,c of the x-rays 124 diffracted by the first, second, and third flat Bragg diffractors 110a,b,c. The at least one first x-ray detector 310 can comprise at least one of: a proportional counter, an ionization chamber, a silicon drift detector, a Li-drift silicon or germanium detector, an x-ray scintillator counter, a pin diode detector; an x-ray photon counter with a plurality of active detector elements (e.g., pixels). The at least one first x-ray detector 310 can have an energy resolution less than 25% (e.g., less than 10%) of the mean energy of at least one diffracted portion 130 received by the at least one first x-ray detector 310. The at least one first x-ray detector 310 can be configured to reduce (e.g., minimize; eliminate) contributions from higher diffraction orders or harmonics to the detection electrical signals.

In certain implementations, at least two flat Bragg diffractors 110 of the sequential stack 300 are stacked with one another and another flat Bragg diffractor (e.g., multilayer; single crystal; mosaic crystal) is positioned sequentially (e.g., downstream) along the x-ray propagation axis 122 from the at least two stacked flat Bragg diffractors 110 and is not stacked with the at least two stacked flat Bragg diffractors 110. For example, as shown in FIG. 3B, the apparatus 100 comprises at least one additional flat Bragg diffractor 320 positioned sequentially along the x-ray propagation axis 122 from the sequential stack 300. The apparatus 100 further comprises at least one second x-ray detector 324. The at least one additional flat Bragg diffractor 320 is configured to diffract at least one additional diffracted portion 322 of the x-rays 124 towards the at least one second x-ray detector 324. The at least one additional flat Bragg diffractor 320 can comprise a multilayer diffractor, a single crystal diffractor, a mosaic crystal diffractor, and/or a combination thereof (e.g., an additional sequential stack 300). The at least one second x-ray detector 324 can comprise at least one of: a proportional counter, an ionization chamber, a silicon drift detector, an x-ray scintillator counter, a pin diode detector; an x-ray photon counter with a plurality of active detector elements (e.g., pixels). In certain implementations, positioning and alignment of the at least one second x-ray detector 324 is performed using computer controlled motorized motion stages.

In certain implementations, the apparatus 100 further comprises at least one third x-ray detector 330 configured to receive the x-rays 124 that are transmitted through the sequential stack 300 (see, e.g., FIG. 3C) or through the sequential stack 300 and the at least one additional flat Bragg diffractor 320 (see, e.g., FIG. 3D). The sequential stack 300 can be configured to have an x-ray transmission greater than 1% for x-rays 124 to be detected by the at least one third x-ray detector 330. The at least one first x-ray detector 310 can comprise a pixel array detector (e.g., photon counting pixel array detector having at least one energy threshold configured to reject x-rays with x-ray energies below the at least one energy threshold and/or to reject x-rays with x-ray energies above the at least one energy threshold) and the at least one third x-ray detector 330 can comprise an energy dispersive detector (e.g., silicon drift detector, Li-drift silicon or germanium detector, photon counting detector with selectable energy window, superconductor-based microcalorimeter). The pixel array detector can be configured to have first pixels receive the first diffracted portion 130a, second pixels receive the second diffracted portion 130b, and third pixels receive the third diffracted portion 130c, the first pixels different from the second and third pixels and the second pixels different from the third pixels. In certain implementations, positioning and alignment of the at least one third x-ray detector 330 is performed using computer controlled motorized motion stages.

In certain implementations, the sequential stack 300 is configured to diffract at least one predetermined characteristic x-ray line having a relatively weak intensity (e.g., due to low concentrations of the related atomic elements and/or low fluorescence yields) or a relatively low x-ray energy, and the at least one first x-ray detector 310 comprises an energy dispersive detector. The at least one predetermined characteristic x-ray line can be used to resolve spectral overlay by the at least one third x-ray detector 330, thereby allowing analysis of a wide spectral range of x-rays with sufficient signal-to-noise ratios for detecting weak spectral lines and/or resolving interfering spectral lines.

In certain implementations, the sequential stack 300 and the at least one x-ray detector 310 are configured to concurrently measure multiple energy bands at the same time, such as measuring a plurality of characteristic x-ray lines concurrently. For example, the Cu L_{α} x-ray line can be measured using a multilayer diffractor of the sequential stack 300 and the Cu K_{α1} x-ray line can be concurrently measured with a single crystal or a mosaic crystal of the sequential stack 300. In certain other implementations, the sequential stack 300 and the at least one x-ray detector 310 are configured to use a single crystal or a mosaic crystal of the sequential stack 300 to concurrently measure the O K_{α} x-ray line while another flat Bragg diffractor 110 of the sequential stack 300 is used to measure at least one of the Cu K_{α1} x-ray line and Cu L_{α} x-ray line.

In certain implementations, the apparatus 100 further comprises at least one x-ray shield that is not substantially transmissive to the x-rays 124 and is configured to be selectively positioned to either allow a corresponding diffracted portion 130 of the x-rays 124 to reach the at least one x-ray detector 310 or to block the corresponding diffracted portion 130 of the x-rays 124 from reaching the at least one x-ray detector 310. For example, the at least one x-ray shield can controllably block the first diffracted portion 130 from reaching the at least one x-ray detector 310 such that the at least one x-ray detector 310 only receives the second diffracted portion 130b and/or the third diffracted portion 130c to provide higher energy resolutions.

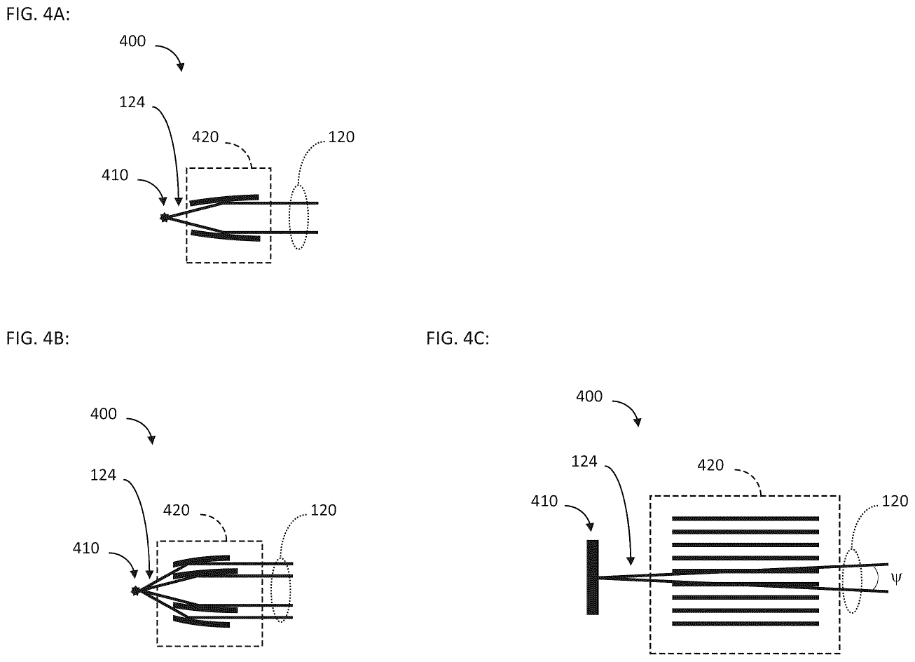

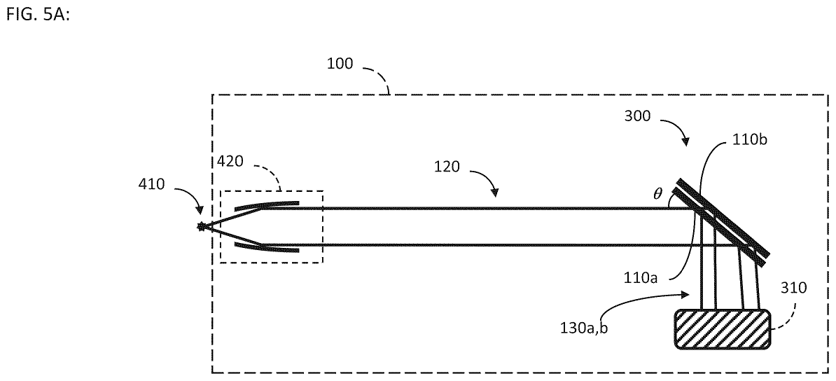

FIGS. 4A-4C schematically illustrate three example x-ray beam sources 400 (e.g., primary source; secondary source) of a substantially collimated x-ray beam 120 in accordance with certain implementations described herein. The x-ray beam source 400 comprises an x-ray source 410 and at least one collimating x-ray optic 420 configured to receive x-rays 124 propagating from the x-ray source 410 and to form the collimated x-ray beam 120 (e.g., having an angular beam divergence less than 30 mrad in at least one plane comprising the x-ray propagation axis 122 and/or in at least one direction substantially perpendicular to the x-ray propagation axis 122). The x-ray beam source 400 is configured to output a substantially collimated (e.g., parallel) x-ray beam 120 having a small angular beam divergence (e.g., less than 30 mrad; less than 20 mrad; less than 10 mrad; less than 5 mrad; less than 3 mrad; less than 2 mrad; less than 1 mrad; less than 0.3 mrad; less than 0.2 mrad) along the x-ray propagation axis 122 (e.g., the longitudinal axis of the at least one collimating x-ray optic 420). In certain implementations, positioning and alignment of at least one of the x-ray source 410 and the at least one collimating x-ray optic 420 is performed using at least one computer controlled motorized motion stage.

In certain implementations, the x-ray source 410 is configured to generate the x-rays 124 in response to incidence of ionizing radiation (e.g., x-rays; charged particles; electrons; protons). As shown in FIGS. 4A and 4B, the x-ray source 410 can comprise a point source (e.g., the x-rays 124 propagating from a spot size less than 200 microns or less than 30 microns in at least one direction substantially perpendicular to the x-ray propagation axis 122). As shown in FIG. 4C, the x-ray source 410 can comprise an extended source (e.g., the x-rays 124 propagating from a range of positions in a range of 20 millimeters to 1000 millimeters along at least one direction substantially perpendicular to the x-ray propagation axis 122). The x-ray source 410 can comprise a sample to be analyzed using the apparatus 100, with the sample irradiated by ionizing radiation to generate the x-rays 124 (e.g., the sample irradiated by a conventional laboratory source of electrons or x-rays, synchrotron radiation source, or other x-ray source that emits broadband or multi-energy x-rays). In certain implementations, the x-ray source 410 is not a component of the apparatus 100, while in certain other implementations, the x-ray source 410 is a component of the apparatus 100.

In certain implementations, the at least one collimating x-ray optic 420 comprises a monocapillary optic (e.g., single capillary optic; mirror optic). In certain implementations, an inner functional surface of the monocapillary optic has a paraboloidal shape, ellipsoidal shape, or a combination of a hyperboloidal shape with either a paraboloidal shape or ellipsoidal shape. As shown in FIG. 4A, the monocapillary optic receives the x-rays 124 from the x-ray source 410 over a corresponding solid angle of collection and reflects the x-rays 124 into the substantially collimated x-ray beam 120. In certain implementations, the inner surface of the monocapillary optic is coated with a layer of high mass density material (e.g., Pt; Ir). In certain implementations, the inner surface of the monocapillary optic is coated with multilayers of alternative low mass density and high mass density materials. For example, the periodicity (e.g., spacing) of the multilayers can be substantially constant. For another example, the periodicity of the multilayers can vary along the optical axis of the monocapillary optic (e.g., longitudinally graded), along a direction substantially perpendicular to the optical axis of the monocapillary optic, or a combination of both.

In certain implementations, the at least one collimating x-ray optic 420 comprises a polycapillary optic (e.g., a plurality of single capillary optics with paraboloidal surfaces nested coaxially; a type III Wolter optic) or a plurality of nested mirror optics (e.g., nested paraboloidal mirror optics; a paraboloidal mirror lens co-axially nested inside a Wolter optic). For example, the Wolter optic can have a hyperboloidal surface segment and a paraboloidal surface segment configured such that a focus of the hyperboloidal surface segment is aligned with the x-ray source 410 and the focus of the paraboloidal surface segment is aligned to another focus of the hyperboloidal surface segment. As shown in FIG. 4B, the polycapillary optic or nested mirror optic receives the x-rays 124 from the x-ray source 410 over a corresponding solid angle of collection and reflects the x-rays 124 into the substantially collimated x-ray beam 120. In certain implementations, the inner surface of the polycapillary optic is coated with a layer of a material different from the substrate material (e.g., glass) of the polycapillary optic. The coating material can be configured to improve the x-ray reflectivity of the polycapillary optic. For example, the coating material can comprise atomic elements with atomic numbers smaller than 15 (e.g., B₄C; MgO; LiF; Si₃N₄; SiO₂; BeO) and/or at least one of: Ni, Cr, Cu. Techniques for applying the coating material include but are not limited to: atomic layer deposition and chemical vapor deposition. In certain implementations, the coating material comprises an organic material with a mass density less than 1.5 g/cm³. Such a coating material can be used to reduce the critical angle of the reflecting surfaces. The coating material can be used to achieve lower angular beam divergence of the polycapillary optic for use in a wavelength spectrometer where a flat diffractor (e.g., single crystal; double crystal) is configured after the polycapillary optic.

In certain implementations, the at least one collimating x-ray optic 420 comprises at least one Soller slit. As shown in FIG. 4B, the at least one Soller slit is configured to receive the x-rays 124 from the x-ray source 410 and to limit the angular spread W of the x-rays 124 emitted from the at least one Soller slit.

In certain implementations, the at least one collimating x-ray optic 420 comprises a compound capillary optic comprising a monocapillary optic and a polycapillary optic having a hollow core, the monocapillary optic nested inside the hollow core. The polycapillary optic can be produced by removing one or more capillaries near the center axis of a polycapillary optic or by producing a polycapillary optic without capillaries near the central axis. The quadric surface of the monocapillary optic can be ellipsoidal, paraboloidal, hyperboloidal, or a combination thereof. The monocapillary optic and the polycapillary optic can be rigidly attached to one another with their optical axes substantially parallel to one another (e.g., colinear with one another, defining a common longitudinal axis, along the x-ray propagation axis 122).

In certain implementations, the compound capillary optic is configured to produce the substantially collimated x-ray beam 120. The portion of the x-ray beam 120 produced by the polycapillary optic has larger angular beam divergence than does the portion of the x-ray beam 120 produced by the monocapillary optic. The optical properties of the compound capillary optic can be configured for x-ray analysis with the x-ray beam 120 and an x-ray wavelength dispersive spectrometer (e.g., small angle x-ray scattering, single crystal x-ray diffraction). For example, for an x-ray wavelength dispersive spectrometer in which the compound capillary optic is placed upstream of a flat Bragg diffractor 110 (e.g., a single crystal, mosaic crystal, stacked crystals diffractor, or multilayer), the larger angular beam divergence of the polycapillary optic can be configured to provide higher efficiency with coarser energy resolution while the lower angular beam divergence of the monocapillary optic can be configured to provide higher energy resolution but lower flux.

In certain implementations, the compound capillary optic further comprises at least one central beam stop configured to block x-rays entering or exiting the monocapillary optic and/or at least one aperture to block x-rays entering or exiting the polycapillary optic, thereby selecting the beam portion from the polycapillary optic and/or the beam portion from the monocapillary optic. The at least one central beam stop can be controllably moved (e.g., via at least one computer controlled motorized motion stage) to block or to allow x-rays 124 to impinge the monocapillary optic and/or to propagate from the monocapillary optic towards the downstream flat Bragg diffractors 110 or sequential stack 300. The at least one aperture can be controllably moved (e.g., via at least one computer controlled motorized motion stage) to block or to allow x-rays 124 to impinge the polycapillary optic and/or to propagate from the polycapillary optic towards the downstream flat Bragg diffractors 110 or sequential stack 300.

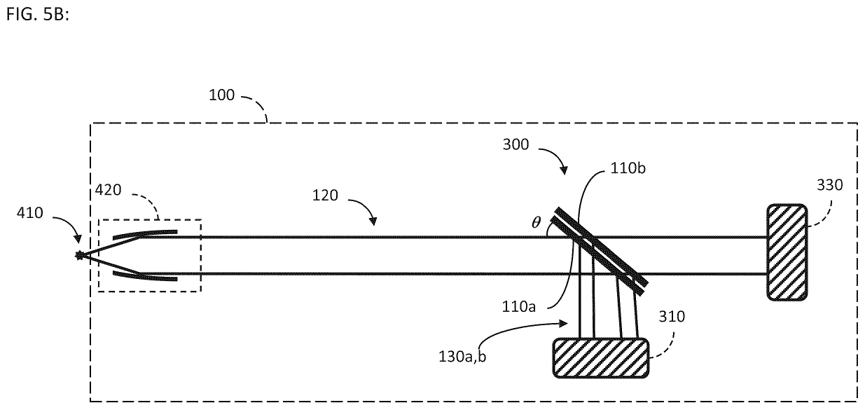

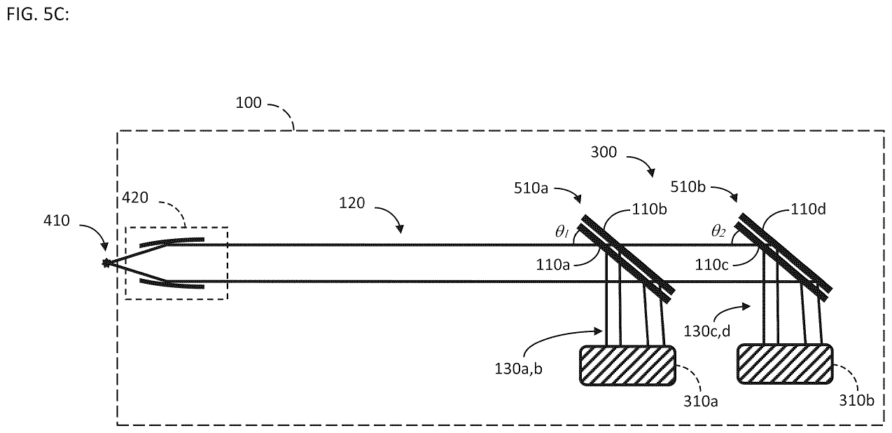

FIGS. 5A-5C schematically illustrate three example apparatus 100 comprising at least one stacked plurality of flat Bragg diffractors 110 in accordance with certain implementations described herein. In FIGS. 5A-5C, the apparatus 100 is an x-ray wavelength dispersive spectrometer (e.g., sequential wavelength dispersive spectrometer) that comprises the plurality of stacked flat Bragg diffractors 110, the at least one x-ray detector 310, and the at least one x-ray collimating optic 420 (e.g., but not the x-ray source 410). The plurality of stacked flat Bragg diffractors 110 of FIGS. 5A-5C comprises a pair of flat crystal diffractors (e.g., first and second flat Bragg diffractors 110a,b; single crystals; mosaic crystals) that are stacked with one another and that are configured to direct corresponding diffracted portions 130a,b towards the at least one first x-ray detector 310. The at least one x-ray detector 310 of FIGS. 5A and 5B is configured to receive both the first and second diffracted portions 130a,b.

The at least one x-ray collimating optic 420 of FIGS. 5A-5C can comprise a plurality of single capillary optics that are coaxially nested. An inner single capillary optic can be configured to output a substantially collimated (e.g., substantially parallel) x-ray beam 120 with a maximum x-ray energy band higher than that of an x-ray beam output by an outer single capillary optic. In certain implementations, the at least one collimating x-ray optic 420 comprises two single capillary optics each with a paraboloidal surface, the two single capillary optics configured such that their foci are aligned with the x-ray source 410 (e.g., primary source; secondary source) and the inner capillary optic is configured to reflect and collimate x-rays of energies less than 20 keV (e.g., less than 10 keV; less than 8 keV; less than 5 keV), while the outer capillary optic is configured to reflect and collimate x-rays of energies less than 3 keV (e.g., less than 2 keV; less than 1 keV; less than 0.5 keV).

In certain implementations, at least one flat Bragg diffractor 110 of the at least one stacked plurality of flat Bragg diffractors 110 is configured to diffract one x-ray fluorescence line of lower energy of an atomic element (e.g., L_{α1} x-ray line of Cu, or L_{α1} x-ray line of Pt) and at least one other flat Bragg diffractor 110 of the at least one stacked plurality of flat Bragg diffractors 110 is configured to diffract one x-ray fluorescence line of higher energy of the same atomic element (e.g., K_{α1} x-ray line of Cu, or K_{α1} x-ray line of Pt). For example, the first flat Bragg diffractor 110a configured to diffract the lower energy x-ray fluorescence line can be positioned upstream of the second flat Bragg diffractor 110b configured to diffract the higher energy x-ray fluorescence line. Certain such implementations can enable probing of the depth of the atomic element from a surface of the sample containing the atomic element. For example, the material and diffraction plane Miller index of at least one upstream flat Bragg diffractor 110 (e.g., selected from the group consisting of. InSb, PET, ADP, RAP, beryl, TIAP, and quartz) can be configured to diffract x-rays with lower energy (e.g., less than 2 keV; less than 1 keV; less than 0.5 keV) and at least one downstream flat Bragg diffractor 110 (e.g., a single crystal; stacked flat crystals; selected from the group consisting of: Si, Ge, LiF, HOPG, and HAPG) can be configured to diffract x-rays with higher energy (e.g., greater than 3 keV; greater than 5 keV; greater than 10 keV).

In certain implementations, the first flat Bragg diffractor 110a is configured to diffract an x-ray fluorescence line of an atomic element (e.g., L_{α1} x-ray line of Cu; L_{α1} x-ray line of Pt) and the second flat Bragg diffractor 110b is configured to diffract x-rays of energy slightly smaller or larger than that of the first flat Bragg diffractor 110a to provide background for more accurate measurement of the x-ray fluorescence line.

The apparatus 100 of FIG. 5B further comprises at least one third x-ray detector 330 (e.g., energy dispersive detector) configured to receive x-rays 124 that are transmitted through the plurality of stacked flat Bragg diffractors 110 (e.g., the at least one third x-ray detector 330 is downstream from the first and second flat Bragg diffractors 110a,b). Examples of the at least one third x-ray detector 330 include but are not limited to: a proportional counter; an ionization chamber; a silicon drift detector; lithium-doped germanium or silicon detector; an x-ray scintillator counter; a pin diode detector; a pixel array x-ray photon counter.

In certain such implementations, the apparatus 100 comprises both an x-ray wavelength dispersive spectrometer and an energy dispersive spectrometer. For example, the at least one wavelength dispersive spectrometer can be configured to measure characteristic x-ray lines having energy differences less than the energy resolution of the energy dispersive detector (e.g., Si K x-ray lines; Ta Mα x-ray lines; W Mα x-ray lines). In certain implementations, the at least one wavelength dispersive spectrometer is configured to measure at least one characteristic x-ray line having a low signal to background ratio (e.g., due to either low concentration of the at least one atomic element associated with the at least one characteristic x-ray line or a large background contribution to the detected signal). In certain implementations, the plurality of stacked flat Bragg diffractors 110 is configured to analyze x-ray fluorescence spectral lines of a plurality of atomic elements with sufficient energy resolution that cannot be resolved by the energy dispersive detector.

In certain implementations, the apparatus 100 can comprise a longitudinal x-ray wavelength dispersive spectrometer comprising a plurality of wavelength dispersive spectrometers that are longitudinally arranged along the x-ray propagation axis 122. For example, the apparatus 100 of FIG. 5C comprises a first wavelength dispersive spectrometer (WDS) 510a comprising a first pair of stacked flat Bragg diffractors 110 (e.g., first and second flat Bragg diffractors 110a,b that are stacked with one another) and a first x-ray detector 310a configured to receive the diffracted portions 130a,b from the first and second flat Bragg diffractors 110a,b. The apparatus 100 of FIG. 5C further comprises a second WDS 510b comprising a second pair of stacked flat Bragg diffractors 110 (e.g., third and fourth flat Bragg diffractors 110c,d that are stacked with one another and are separate from the first and second flat Bragg diffractors 110a,b) and a second x-ray detector 310b configured to receive the diffracted portions 130c,d from the third and fourth flat Bragg diffractors 110c,d. The second WDS 510b is positioned sequentially (e.g., downstream) from the first WDS 510a. The spectral bands of the first and second x-ray wavelength dispersive spectrometers have minimal spectral overlap (e.g., less than 3%; less than 1%). In certain implementations, the third and fourth flat Bragg diffractors 110c,d of the second WDS 510b can be replaced by a single flat crystal diffractor. For example, the single flat crystal diffractor can comprise a diamond, LiF, Si, or Ge crystal (e.g., in symmetric cut form or asymmetric cut form), a channel cut crystal, a stack crystals diffractor, or a mosaic crystal (e.g., HAPG or HAPG) and can be placed at a position that is upstream or downstream relative to first and second diffractors 110a,b. The first and second WDSs 510a,b can be configured such that the at least one flat Bragg diffractor 110 or a stacked plurality of flat Bragg diffractors 110 of the first WDS 510a has higher x-ray transmission for the x-rays 124 to be diffracted by the at least one flat Bragg diffractor 110 of the second WDS 510b than do the at least one flat Bragg diffractor 110 or a stacked plurality of flat Bragg diffractors 110 of the second WDS 510b. Other configurations can comprise additional flat Bragg diffractors 110 and/or stacked plurality of flat Bragg diffractors 110 and x-ray detectors 310 to provide a longitudinal x-ray wavelength dispersive spectrometer comprising one or more additional WDSs.

In certain implementations, at least two of the flat Bragg diffractors 110 of the longitudinal wavelength dispersive spectrometer of FIG. 5C are configured to measure two specific x-ray energies (e.g., two characteristic x-ray lines). In certain implementations, each of the flat Bragg diffractors 110 or stacked plurality of flat Bragg diffractors 110 is configured to measure one specific characteristic x-ray line. In certain implementations, the Bragg angle of at least one of the flat Bragg diffractors 110 or stacked plurality of flat Bragg diffractors 110 is configured to be scanned over a predetermined angular range to measure the x-ray spectrum of the substantially parallel x-ray beam 120. In certain implementations, the number of flat Bragg diffractors 110 including stacked flat Bragg diffractors 110 is in a range of 2 to 10. In certain implementations, the positioning and alignment of at least some of the components of the longitudinal wavelength dispersive spectrometer is performed via computer controlled motorized motion stages.

In certain implementations, the at least two flat Bragg diffractors 110 of a plurality of stacked flat Bragg diffractors 110 comprise a first flat crystal diffractor configured to diffract a first fluorescence x-ray line of lower energy of an atomic element (e.g., L_{α1} x-ray line of Cu; L_{α1} x-ray line of Pt) and a second flat crystal diffractor configured to diffract a second fluorescence x-ray line of higher energy of the same atomic element (e.g., K_{α1} x-ray line of Cu; K_{α1} x-ray line of Pt). The first flat crystal diffractor can be positioned upstream of the second flat crystal diffractor. Certain such implementations can enable probing of the depth of the atomic element from a surface of the sample containing the atomic element.

In certain implementations, the at least two flat Bragg diffractors 110 of a plurality of stacked flat Bragg diffractors 110 comprise a first flat crystal diffractor configured to diffract a first fluorescence x-ray line of an atomic element (e.g., L_{α1} x-ray line of Cu; L_{α1} x-ray line of Pt) and a second flat crystal diffractor configured to diffract x-rays 124 of energy slightly smaller or larger than that of the first flat crystal diffractor to provide background for more accurate measurement of the fluorescence x-ray line.

### Example Implementations for x-Ray Fluorescence (XRF) Composition Analysis

In certain implementations, the diffracted portions 130 of x-rays 124 diffracted by at least two flat Bragg diffractors 110 of a plurality of stacked flat Bragg diffractors 110 are portions of a single characteristic x-ray line and have minimal spectral overlap (e.g., less than 5%; less than 1%) between them (e.g., a first flat Bragg diffractor 110a diffracts a first diffracted portion 130a comprising a lower energy half of the characteristic x-ray line and a second flat Bragg diffractor 110b diffracts a second diffracted portion 130b comprising a higher energy half of the characteristic x-ray line). For example, the at least two flat Bragg diffractors 110 can comprise two LiF(111) crystal diffractors having an angular difference of about 40 microradians, each LiF(111) crystal diffractor diffracting approximately one-half of the Cu K_{α1} x-ray line. Such implementations can be used when the intrinsic energy resolution ΔE_{c} of the flat Bragg diffractor 110 is narrower than the total energy resolution ΔE for a given measurement (e.g., the crystal diffractors can operate at high Bragg angles when the angular beam divergence Δθ is larger than the Darwin widths of the stacked flat Bragg diffractors 110). In certain implementations, at least two stacked flat Bragg diffractors 110 are configured to concurrently diffract two predetermined characteristic x-ray fluorescence lines of one atomic element (e.g., Cu K_{α1} x-ray line and Cu K_{α2} x-ray line) and a single x-ray detector 310 (e.g., either energy resolving or not energy resolving) is configured to detect the diffracted portions 130. In certain implementations, the x-ray detector 310 has an energy resolution that is less than 25% (e.g., less than 10%) of the mean (e.g., central) energy of at least one diffracted portion 130 diffracted by the stacked flat Bragg diffractors 110 and received by the x-ray detector 310 (e.g., to minimize or eliminate higher diffraction orders or harmonics contribution to the detected signal).

For example, the plurality of stacked flat Bragg diffractors 110 can comprise two flat mosaic crystal diffractors, one flat Bragg diffractor 110 configured to diffract Cu K_{α1} x-rays and the other flat Bragg diffractor 110 configured to diffract Cu K_{α2} x-rays. In certain implementations, at least two stacked flat Bragg diffractors 110 are configured to diffract x-rays with ΔE optimized for a given analysis (e.g., two characteristic x-ray lines of an atomic element, such as ΔE=20 eV for Cu K_{α1} x-ray line and K_{α2} x-ray line; XANES measurements with an energy resolving power E/ΔE greater than or equal to 10⁻⁴; EXAFS measurements with an energy resolution of about 3-6 eV).

In certain implementations, at least two stacked flat Bragg diffractors 110 of a plurality of stacked flat Bragg diffractors 110 are configured to concurrently diffract two predetermined characteristic x-ray fluorescence lines of two different atomic elements and a single energy dispersive x-ray detector 310 (e.g., silicon drift detector with an energy resolution finer than the energy difference between the two predetermined characteristic x-ray lines) is configured to detect the diffracted characteristic x-rays.

In certain implementations, multiple flat Bragg diffractors 110 are configured to concurrently diffract a predetermined plurality of characteristic x-ray fluorescence lines of multiple atomic elements and an energy dispersive detector 310 (e.g., silicon drift detector) having sufficient energy resolution to differentiate the characteristic x-ray lines is used to detect the diffracted characteristic x-rays. For example, a sequentially stacked crystal analyzer can comprise at least three crystal diffractors configured with appropriate Bragg angle differences to concurrently diffract three K_{α1} x-ray lines of three atomic elements (e.g., Cr, Fe, Cu) with energy differences greater than 120 eV (e.g., greater than 200 eV; greater than 1000 eV). The analyzer can further comprise an energy dispersive detector (e.g., silicon drift detector, lithium drift detector, or charge coupled detector) configured to detect the diffracted characteristic x-ray lines.

In certain implementations, some of the flat Bragg diffractors 110 of a plurality of stacked flat Bragg diffractors 110 are configured to diffract one or two characteristic x-ray lines of a predetermined atomic element (e.g., Cu K_{α1} x-ray line and Cu K_{α2} x-ray line) while other flat Bragg diffractors 110 are configured to diffract characteristic line(s) of different predetermined atomic element(s). In certain implementations, some of the flat Bragg diffractors 110 of the plurality of stacked flat Bragg diffractors 110 are configured to diffract one or two characteristic x-ray lines of a predetermined atomic element (e.g., Cu K_{α1} x-ray line and Cu K_{α2} x-ray line) while other flat Bragg diffractors 110 are configured to diffract x-rays near at least one of the predetermined characteristic x-ray lines for obtaining background counts. In certain implementations, the upstream flat Bragg diffractor(s) 110 are configured to diffract characteristic line(s) of weaker intensity while the downstream flat Bragg diffractor(s) 110 are configured to diffract characteristic x-ray lines of higher intensity. In certain implementations, the upstream flat Bragg diffractors 110 are selected have an x-ray transmission greater than 2% for x-rays to be diffracted by at least one downstream flat Bragg diffractor 110.

### Example Implementations for XAS

In certain implementations for XAS applications, such as x-ray absorption near edge structure (XANES) or extended x-ray absorption fine structure (EXAFS), at least two flat Bragg diffractors 110 of a plurality of stacked flat Bragg diffractors 110 are configured to diffract x-rays having x-ray energies within a predetermined energy resolution with minimal spectral overlap (e.g., less than 5%; less than 1%) between the diffracted portions 130. For example, one diffracted portion 130 can correspond to the lower energy half of the characteristic x-ray line and the other diffracted portion 130 can correspond to the higher energy half of the characteristic x-ray line (e.g., two LiF(111) crystal diffractors having an angular difference of about 40 microradians for Cu K_{α1} x-rays). Such implementations can be used when the intrinsic energy resolution ΔE_{c} of the flat Bragg diffractor 110 is narrower than the total energy resolution E for a given measurement (e.g., the crystal diffractors can operate at high Bragg angles when the angular beam divergence Δθ is larger than the Darwin widths of the stacked flat Bragg diffractors 110). In certain implementations, at least two stacked flat Bragg diffractors 110 of the plurality of stacked flat Bragg diffractors 110 are configured to concurrently diffract at least two predetermined x-ray energies having an energy difference larger than the energy resolution of the x-ray detector 310 (e.g., silicon drift detector) configured to record the diffracted portions 130 diffracted by the at least two stacked flat Bragg diffractors 110. For XANES measurements, the energy difference can be less than 250 eV but larger than the energy resolution of the x-ray detector 310. For EXAFS measurements, the energy difference can be less than 700 eV but larger than the energy resolution of the x-ray detector 310.

In certain implementations, the stacked flat Bragg diffractors 110 are scanned over an angular range with respect to the x-ray propagation axis 122 of the collimated x-ray beam 120 in response to a previous XAS measurement. In certain implementations, the analyzer comprises the plurality of stacked flat Bragg diffractors 110 and at least one single crystal diffractor 320 configured to diffract x-rays having x-ray energies within a predetermined energy range (e.g., in a range of 100 eV to 200 eV for XANES; in a range of 500 eV to 1000 eV for EXAFS). In certain implementations, a plurality of x-ray detectors 310 are configured to detect x-rays diffracted by the stacked flat Bragg diffractors 110 and the at least one single crystal diffractor 320. In certain implementations, all the stacked flat Bragg diffractors 110 are configured such that the energy resolving power (Eₒ/ΔE) for the diffracted x-rays by each flat Bragg diffractor 110 of the plurality of stacked flat Bragg diffractors 110 is greater or equal to 10⁻⁴ for XANES measurements and/or the energy resolution E is less than 6 eV (e.g., less than 3 eV) for EXAFS measurements. In certain implementations, the plurality of stacked flat Bragg diffractors 110 is configured to diffract x-rays of predetermined x-ray energies for a given XAS measurement (e.g., x-ray energies corresponding to pre-edge, white line, predetermined x-ray energies containing important structural information for the measurement, such as high absorption and/or low absorption energies). In certain implementations, the number of energy measurement points can be in a range of 5 to 100.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements, and/or steps are in any way required for one or more implementations. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Conjunctive language such as the phrase “at least one of X, Y, and Z,” unless specifically stated otherwise, is to be understood within the context used in general to convey that an item, term, etc. may be either X, Y, or Z. Thus, such conjunctive language is not generally intended to imply that certain implementations require the presence of at least one of X, at least one of Y, and at least one of Z.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the structures and/or methods are discussed herein in terms of elements labeled by ordinal adjectives (e.g., first, second, etc.), the ordinal adjectives are used merely as labels to distinguish one element from another, and the ordinal adjectives are not used to denote an order of these elements or of their use.

Various configurations have been described above. It is to be appreciated that the implementations disclosed herein are not mutually exclusive and may be combined with one another in various arrangements. Although this invention has been described with reference to these specific configurations, the descriptions are intended to be illustrative of the invention and are not intended to be limiting. Various modifications and applications may occur to those skilled in the art without departing from the true spirit and scope of the invention. Thus, for example, in any method or process disclosed herein, the acts or operations making up the method/process may be performed in any suitable sequence and are not necessarily limited to any particular disclosed sequence. Features or elements from various implementations and examples discussed above may be combined with one another to produce alternative configurations compatible with implementations disclosed herein. In addition, although the disclosed methods and apparatuses have largely been described in the context of various devices, various implementations described herein can be incorporated in a variety of other suitable devices, methods, and contexts.

Various aspects and advantages of the implementations have been described where appropriate. It is to be understood that not necessarily all such aspects or advantages may be achieved in accordance with any particular implementation. Thus, for example, it should be recognized that the various implementations may be carried out in a manner that achieves or optimizes one advantage or group of advantages as taught herein without necessarily achieving other aspects or advantages as may be taught or suggested herein.

What is claimed is:

1. An apparatus comprising:
a plurality of stacked flat Bragg diffractors comprising at least a first flat Bragg diffractor and a second flat Bragg diffractor, the first and second flat Bragg diffractors positioned sequentially along an x-ray propagation axis of an x-ray beam comprising x-rays and having an angular beam divergence less than 30 mrad in at least one direction.

2. The apparatus of claim 1, wherein the first flat Bragg diffractor comprises a substantially flat multilayer, single crystal, or mosaic crystal configured to diffract at least some of the x-rays in accordance with Bragg's law.

3. The apparatus of claim 1, wherein the first flat Bragg diffractor and the second flat Bragg diffractor are connected to one another and are configured to be sequentially impinged by the x-ray beam.

4. The apparatus of claim 1, wherein the second flat Bragg diffractor is downstream from the first flat Bragg diffractor, the first flat Bragg diffractor configured to diffract a first diffracted portion of the x-rays and to transmit a first transmitted portion of the x-rays, the second flat Bragg diffractor configured to diffract a second diffracted portion of the first transmitted portion and to transmit a second transmitted portion of the first transmitted portion, the first diffracted portion having a first mean x-ray energy E₁ and a first energy resolution ΔE₁ and the second diffracted portion having a second mean x-ray energy E₂ and a second energy resolution ΔE₂, the second x-ray energy E₂ different from the first x-ray energy E₁.

5. The apparatus of claim 4, wherein the first flat Bragg diffractor comprises a multilayer Bragg diffractor configured to diffract x-rays having x-ray energies less than 1 keV and the second flat Bragg diffractor comprises a single crystal and/or mosaic crystal and is configured to diffract x-rays having x-ray energies greater than 1 keV.

6. The apparatus of claim 5, wherein the multilayer Bragg diffractor has a d-spacing in a range of 3 nanometers to 30 nanometers, the single crystal comprises a material selected from the group consisting of: diamond, quartz, graphite, stack of graphene layers, other materials comprising low atomic number elements, silicon (Si), germanium (Ge), lithium fluoride (LiF), mica, indium antimonide (InSb), polyethylene terephthalate (PET), ammonium dihydrophosphate (ADP), rubidium acid phtahalate (RAP), beryl, and thallium acid phthalate (TIAP), and the mosaic crystal comprises a material selected from the group consisting of: highly annealed pyrolitic graphite (HAPG) and highly oriented pyrolitic graphite (HOPG).

7. The apparatus of claim 4, wherein the plurality of stacked flat Bragg diffractors further comprises a third flat Bragg diffractor downstream from the second flat Bragg diffractor, the third flat Bragg diffractor configured to diffract a third diffracted portion of the second transmitted portion and to transmit a third transmitted portion of the second transmitted portion, the third diffracted portion having a third mean x-ray energy E₃ and a third energy resolution ΔE₃, the third x-ray energy E₃ different from the first x-ray energy E₁ and from the second x-ray energy E₂.

8. The apparatus of claim 7, wherein the second flat Bragg diffractor is configured to diffract x-rays having x-ray energies in a range of 1 keV to 3 keV, and the third flat Bragg diffractor comprises a single crystal and/or mosaic crystal and is configured to diffract x-rays having x-ray energies greater than 3 keV.

9. The apparatus of claim 7, wherein the first flat Bragg diffractor has a first x-ray transmittance greater than 1% for x-rays having the second x-ray energy E₂ and a third x-ray transmittance greater than 1% for x-rays having the third x-ray energy E₃, and the second flat Bragg diffractor has a second x-ray transmittance greater than 1% for x-rays having the third x-ray energy E₃.

10. The apparatus of claim 1, wherein the plurality of stacked flat Bragg diffractors are positioned along the x-ray propagation axis within a distance along the x-ray propagation axis less than 200 millimeters.

11. The apparatus of claim 1, wherein at least two adjacent flat Bragg diffractors of the plurality of stacked flat Bragg diffractors are positioned along the x-ray propagation axis spaced from one another along the x-ray propagation axis by less than 30 millimeters.

12. The apparatus of claim 1, wherein at least two flat Bragg diffractors of the plurality of stacked flat Bragg diffractors comprise the same material as one another.

13. The apparatus of claim 12, wherein the at least two flat Bragg diffractors are configured to diffract x-rays with atomic planes having the same Miller indices as one another and the x-rays are incident to each of the at least two flat Bragg diffractors at different Bragg angles such that a spectral bandwidth overlap between diffracted x-rays from the at least two flat Bragg diffractors is substantially zero.

14. The apparatus of claim 12, wherein the x-rays are incident to each of the at least two flat Bragg diffractors at substantially equal Bragg angles and diffracting atomic planes of the at least two flat Bragg diffractors have different d-spacings.

15. The apparatus of claim 1, wherein at least two flat Bragg diffractors of the plurality of stacked flat Bragg diffractors comprise different materials from one another.

16. An apparatus configured to receive an x-ray beam propagating along an x-ray propagation axis with an angular beam divergence less than 30 mrad in at least one direction substantially perpendicular to the x-ray propagation axis, the apparatus comprising:
a plurality of sequentially stacked flat Bragg diffractors that are rigidly connected to one another with a separation between adjacent flat Bragg diffractors less than 200 millimeters, the plurality of sequentially stacked flat Bragg diffractors configured to receive the x-ray beam, each flat Bragg diffractor of the plurality of sequentially stacked flat Bragg diffractors configured to diffract a corresponding diffracted portion of the x-ray beam with a spectral overlap between the diffracted portions from different flat Bragg diffractors less than 25%; and
at least one x-ray detector configured to receive and detect the diffracted portions.

17. The apparatus of claim 16, wherein the diffracted portions diffracted by at least two flat Bragg diffractors of the plurality of sequentially stacked flat Bragg diffractors have different mean x-ray energies that differ by less than 30 eV.

18. The apparatus of claim 16, wherein the diffracted portions diffracted by at least two flat Bragg diffractors of the plurality of sequentially stacked flat Bragg diffractors have different mean x-ray energies that differ by more than 50 eV.

19. The apparatus of claim 16, wherein the plurality of sequentially stacked flat Bragg diffractors comprises a first set of stacked flat Bragg diffractors and a second set of stacked flat Bragg diffractors, the at least one x-ray detector comprising a first x-ray detector and a second x-ray detector, the first set of stacked flat Bragg diffractors configured to diffract x-rays towards the first x-ray detector and the second set of stacked flat Bragg diffractors configured to diffract x-rays towards the second x-ray detector.

20. The apparatus of claim 16, wherein the plurality of sequentially stacked flat Bragg diffractors comprises at least one multilayer diffractor, at least one single crystal diffractor, and/or at least one mosaic crystal diffractor.

21. The apparatus of claim 16, wherein the plurality of sequentially stacked flat Bragg diffractors comprises at least two single crystal diffractors configured such that the x-ray beam has a Bragg angle difference relative to the at least two single crystal diffractors that is greater than 10 microradians.

22. The apparatus of claim 16, wherein the plurality of sequentially stacked flat Bragg diffractors comprises more than two flat Bragg diffractors.

23. The apparatus of claim 16, wherein the plurality of sequentially stacked flat Bragg diffractors comprises at least one flat Bragg diffractor having a thickness along the x-ray propagation axis that is less than 500 microns.

24. The apparatus of claim 16, wherein the plurality of sequentially stacked flat Bragg diffractors is configured to diffract at least two characteristic x-ray lines of one or two atomic elements concurrently.

25. The apparatus of claim 16, further comprising at least one motion stage configured to controllably adjust at least one Bragg angle of at least one flat Bragg diffractor of the plurality of sequentially stacked flat Bragg diffractors.

26. The apparatus of claim 16, wherein the at least one x-ray detector is selected from the group consisting of: proportional counter; ionization chamber; silicon drift detector;
Li-drift silicon or germanium detector; x-ray scintillator counter; pin diode detector; x-ray photon counter with a plurality of active detector elements; pixel array detector; photon counting detector with selectable energy window; superconductor based microcalorimeter.

27. The apparatus of claim 16, wherein the at least one x-ray detector comprises a photon counting pixel array detector having at least one energy threshold configured to reject x-rays with x-ray energies below the at least one energy threshold and/or to reject x-rays with x-ray energies above the at least one energy threshold.

28. The apparatus of claim 16, further comprising at least one collimating x-ray optic configured to receive x-rays propagating from an x-ray source and to form the x-ray beam.

29. An apparatus comprising:
at least one flat Bragg x-ray diffractor configured to receive an x-ray beam and to diffract at least one corresponding diffracted portion of the x-ray beam; and
at least one energy dispersive x-ray detector configured to receive and detect a transmitted portion of the x-ray beam that is transmitted through the at least one flat Bragg x-ray diffractor.
